(19) United States
(12) Patent Application Publication
(10) Pub. No.: US 2025/0197208 A1
(43) Pub. Date: Jun. 19, 2025

(54) HYDROGEN REACTOR SYSTEM FOR CONTINUOUSLY PRODUCING HYDROGEN AND ALUMINA WITH PRESSURE AND TEMPERATURE REGULATION AND CONTROL

(71) Applicant: GH POWER INC., Deep River (CA)

(72) Inventors: Ken STEWART, Deep River (CA); Dave WHITE, Deep River (CA)

(73) Assignee: GH POWER INC., Deep River, ON (CA)

(21) Appl. No.: 18/848,865

(22) PCT Filed: Mar. 22, 2023
(86) PCT No.: PCT/CA2023/050376

§ 371 Date: Sep. 19, 2024

Related U.S. Application Data
(60) Provisional application No. 63/269,741, filed on Mar. 22, 2022.

(51) Int. Cl. C01B 3/08; C01F 7/428

(52) U.S. Cl. CPC C01B 3/08; C01F 7/428; C01B 2203/1619; C01B 2203/1623; C01B 2203/1633

(57) ABSTRACT

Disclosed is a hydrogen reactor system having a hydrogen reactor configured to enable a chemical reaction involving aluminum and water to produce hydrogen and alumina. In accordance with an embodiment, the hydrogen reactor system also has a pressure regulator configured to regulate and control pressure inside the hydrogen reactor during the chemical reaction, a temperature regulator configured to regulate and control temperature inside the hydrogen reactor during the chemical reaction, and an aluminum slurry feed regulator configured to regulate and control a continuous feed of the aluminum and the water as an aluminum slurry into the hydrogen reactor during the chemical reaction, thereby enabling the hydrogen and the alumina to be continuously produced at a controlled rate. The aforementioned regulation and control enables the pressure and the temperature to be purposely operated in an elevated manner, which can increase purity of the hydrogen and the alumina being continuously produced.

### CROSS-REFERENCE TO RELATED APPLICATION

This patent application claims priority to U.S. Provisional Patent Application No. 63/269,741 filed on Mar. 22, 2022 which is hereby incorporated herein by reference in its entirety.

### FIELD OF THE DISCLOSURE

This disclosure relates to process plants, and more particularly to process plants for generating hydrogen and alumina.

### BACKGROUND

A chemical reaction between aluminum and water under certain conditions can produce hydrogen, alumina and energy (i.e. 2Al+3H₂O→H₂+2Al₂O₃+energy). In this way, it is possible to produce hydrogen and alumina. However, the hydrogen and the alumina produced using conventional approaches may have various impurities and lack production efficiency as well.

The conventional approaches of producing hydrogen and alumina leave much to be desired in terms of purity and/or production efficiency. It is desirable to improve upon the conventional approaches by employing technology to eliminate or mitigate some or all of the aforementioned shortcomings.

### SUMMARY OF THE DISCLOSURE

Disclosed is a hydrogen reactor system for continuously producing hydrogen and alumina with pressure and temperature regulation and control. The hydrogen reactor system has a hydrogen reactor configured to enable a chemical reaction involving aluminum and water to produce hydrogen and alumina. In accordance with an embodiment of the disclosure, the hydrogen reactor system also has a pressure regulator configured to regulate and control pressure inside the hydrogen reactor to a target pressure during the chemical reaction, a temperature regulator configured to regulate and control temperature inside the hydrogen reactor to a target temperature during the chemical reaction, and an aluminum slurry feed regulator configured to regulate and control a continuous feed of the aluminum and the water as an aluminum slurry into the hydrogen reactor to a target flow rate during the chemical reaction, thereby enabling the hydrogen and the alumina to be continuously produced at a controlled rate.

Because the pressure and the temperature within the hydrogen reactor are controlled and regulated, the pressure and the temperature can be purposely operated in an elevated manner, which can increase purity of the hydrogen and the alumina being continuously produced by the chemical reaction with a relatively high degree of production efficiency. Conventional approaches for producing hydrogen and alumina are typically limited to small batch type operations that are not continuous, and hence may not achieve the same production efficiency. Moreover, the conventional approaches may not allow the pressure and the temperature to remain elevated in the same controlled and regulated way, and hence may not achieve the same purity. Therefore, the regulating and the controlling of the pressure and the temperature within the hydrogen reactor whilst the aluminum slurry is continuously supplied can provide for substantial benefits over the conventional approaches.

Also disclosed is a method for continuously producing hydrogen and alumina with pressure and temperature regulation and control. The method involves operating a hydrogen reactor to enable a chemical reaction involving aluminum and water to produce hydrogen and alumina. In accordance with an embodiment of the disclosure, the method also involves regulating and controlling pressure inside the hydrogen reactor to a target pressure during the chemical reaction, regulating and controlling temperature inside the hydrogen reactor to a target temperature during the chemical reaction, and regulating and controlling a continuous feed of the aluminum and the water as an aluminum slurry into the hydrogen reactor to a target flow rate during the chemical reaction, thereby enabling the hydrogen and the alumina to be continuously produced at a controlled rate.

Also disclosed is a hydrogen reactor system having a hydrogen reactor configured to enable a chemical reaction involving aluminum and water to produce hydrogen and alumina. In accordance with an embodiment of the disclosure, the hydrogen reactor system also has an aluminum slurry feed regulator configured to regulate and control a continuous feed of the aluminum and the water as an aluminum slurry to a target flow rate into the hydrogen reactor during the chemical reaction, thereby enabling the hydrogen and the alumina to be continuously produced at a controlled rate.

Because the aluminum and the water are continuously supplied to the hydrogen reactor during the chemical reaction, a continuous production of the hydrogen and the alumina is made possible, thereby enabling a relatively high degree of production efficiency. Conventional approaches that perform the chemical reaction in small batch reactions cannot sustain such continuous production and may not achieve the same production efficiency. Therefore, the aluminum slurry feed regulator can provide for substantial benefits over the conventional approaches.

Also disclosed is a method for continuously producing hydrogen and alumina. The method includes operating a hydrogen reactor to enable a chemical reaction involving aluminum and water to produce hydrogen and alumina. In accordance with an embodiment of the disclosure, the method also involves regulating and controlling a continuous feed of the aluminum and the water as an aluminum slurry into the hydrogen reactor to a target flow rate during the chemical reaction, thereby enabling the hydrogen and the alumina to be continuously produced at a controlled rate.

Other aspects and features of the present disclosure will become apparent, to those ordinarily skilled in the art, upon review of the following description of the various embodiments of the disclosure.

### BRIEF DESCRIPTION OF THE DRAWINGS

The following figures set forth embodiments in which like reference numerals denote like parts. Embodiments are illustrated by way of example and not by way of limitation in the accompanying figures.

FIG. 1 is a block diagram of a hydrogen reactor system for continuously producing hydrogen and alumina with pressure and temperature regulation and control, in accordance with an example embodiment of the disclosure.

FIG. 2 is a detailed schematic of another example hydrogen reactor system, in accordance with another embodiment of the disclosure.

FIG. 3 is a detailed schematic of another example hydrogen reactor system, in accordance with another embodiment of the disclosure.

FIG. 4 is a flowchart of a method of continuously producing hydrogen and alumina with pressure and temperature regulation and control.

### DETAILED DESCRIPTION OF EMBODIMENTS

It should be understood at the outset that although illustrative implementations of one or more embodiments of the present disclosure are provided below, the disclosed systems and/or methods may be implemented using any number of techniques. The disclosure should in no way be limited to the illustrative implementations, drawings, and techniques illustrated below, including the exemplary designs and implementations illustrated and described herein, but may be modified within the scope of the appended claims along with their full scope of equivalents.

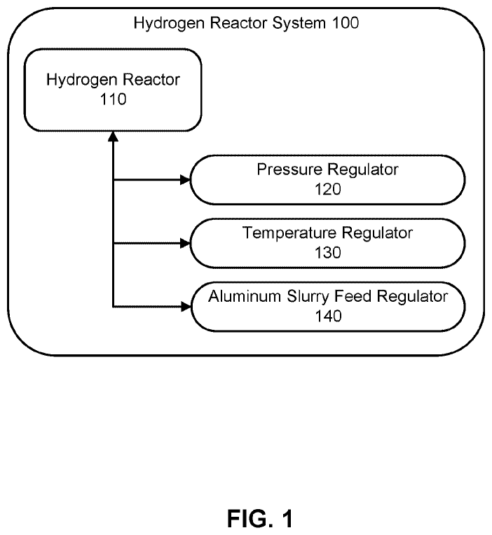

Referring now to FIG. 1, shown is a block diagram of a hydrogen reactor system 100 for continuously producing hydrogen and alumina with pressure and temperature regulation and control, in accordance with an embodiment of the disclosure. The hydrogen reactor system 100 has a hydrogen reactor 110 configured to enable a chemical reaction involving aluminum and water to produce hydrogen, alumina and energy (i.e. 2Al+3H₂O→H₂+2Al₂O₃+energy). In accordance with an embodiment of the disclosure, the hydrogen reactor system 100 also has a pressure regulator 120 configured to regulate and control pressure inside the hydrogen reactor 110 to a target pressure during the chemical reaction, a temperature regulator 130 configured to regulate and control temperature inside the hydrogen reactor 110 to a target temperature during the chemical reaction, and an aluminum slurry feed regulator 140 configured to continuously introduce the aluminum and the water as an aluminum slurry into the hydrogen reactor 110 to continuously sustain production of the hydrogen and the alumina.

Because the pressure and the temperature within the hydrogen reactor 110 are controlled and regulated, the pressure and the temperature can be purposely operated in an elevated manner, which can increase purity of the hydrogen and the alumina being continuously produced by the chemical reaction with a relatively high degree of production efficiency. Conventional approaches for producing hydrogen and alumina are typically limited to small batch type operations that are not continuous, and hence may not achieve the same production efficiency. Moreover, the conventional approaches may not allow the pressure and the temperature to remain elevated in the same controlled and regulated way, and hence may not achieve the same purity. Therefore, the regulating and the controlling of the pressure and the temperature within the hydrogen reactor 110 whilst the aluminum slurry is continuously supplied can provide for substantial benefits over the conventional approaches.

In some implementations, the hydrogen reactor system 100 includes a pressure sensor (not shown) and the pressure regulator 120 implements feedback control (i.e. closed loop control) based on measurements from the pressure sensor to regulate and control pressure inside the hydrogen reactor 110 to the target pressure. In other implementations, there is no such feedback control, and instead open loop control is implemented.

There are many possibilities for the pressure regulator 120. In some implementations, the pressure regulator 120 includes a back-pressure control valve configured to release the hydrogen from the hydrogen reactor 110 at a flow rate that is variable such that the target pressure inside the hydrogen reactor is maintained. Examples of this are provided below. Other implementations are possible. Further example details of how pressure is controlled and regulated are provided below with refence to the subsequent embodiments and accompanying drawings.

In some implementations, the hydrogen reactor system 100 includes a temperature sensor (not shown) and the temperature regulator 130 implements feedback control (i.e. closed loop control) based on measurements from the temperature sensor to regulate and control temperature inside the hydrogen reactor to the target temperature. The target temperature can be maintained by removing exothermic heat released by the chemical reaction. In other implementations, there is no such feedback control, and instead open loop control is implemented.

There are many possibilities for the temperature regulator 130. In some implementations, the hydrogen reactor 110 is cooled using thermal fluid, and the temperature regulator 130 includes a temperature control valve configured to adjust how much of the thermal fluid passes through a heat sink to cool the thermal fluid. Examples of this are provided below. Other implementations are possible. Further example details of how temperature is controlled and regulated are provided below with refence to the subsequent embodiments and accompanying drawings.

In some implementations, the hydrogen reactor system 100 includes a feed control flow sensor (not shown) and the aluminum slurry feed regulator 140 implements feedback control (i.e. closed loop control) based on measurements from the feed control flow sensor to regulate and control a flow of the aluminum slurry provided into the hydrogen reactor 110 to the target flow rate. The target flow rate can be maintained such that the chemical reaction is sustained at a suitable pace. The chemical reaction is “continuous” because of the flow of the aluminum slurry is continuous and not merely a small batch type operation. For example, the chemical reaction can last for hours, days, weeks, etc. In other implementations, there is no such feedback control, and instead open loop control is implemented.

There are many possibilities for the aluminum slurry feed regulator 140. In some implementations, the flow of the aluminum slurry is measured by supply and recirculation flow sensors, and the aluminum slurry feed regulator 140 is configured to adjust the flow of the aluminum slurry into the hydrogen reactor 110 by monitoring a difference between supply and return rates of the aluminum slurry. Other examples of controlling the aluminum feed rate would be to measure the flow of the aluminum slurry to the hydrogen reactor 110 directly and adjust the flow of the aluminum slurry into the hydrogen reactor 110. Other implementations are possible. Further example details of how the flow of the aluminum slurry can be controlled and regulated are provided below with refence to the subsequent embodiments and accompanying drawings.

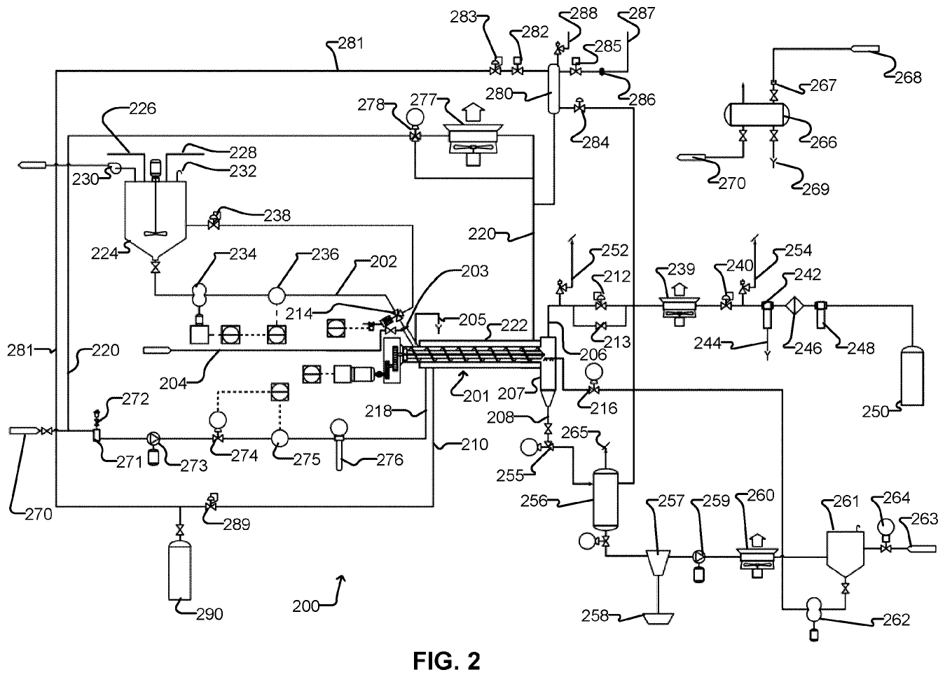

FIG. 2 shows a schematic of another example hydrogen reactor system 200 in accordance with another embodiment of the disclosure. It is to be understood that the hydrogen reactor system 200 is very specific and is provided merely for exemplary purposes.

The system 200 comprises a hydrogen reactor 201 receives an aluminum slurry 202, which is a mixture of water and aluminum in granulated form, and is continuously provided into the hydrogen reactor 201 through a slurry injection nozzle 203. Within the hydrogen reactor 201, a chemical reaction between the aluminum and the water takes place under certain conditions to produce hydrogen, alumina, and exothermic energy in the form of heat (i.e. 2Al+3H₂O→H₂+2Al₂O₃+energy). The hydrogen reactor 201 has an alumina/hydrogen separator 207 at an discharge end thereof with an output for the hydrogen 206 and an output for the alumina 208. The hydrogen reactor 201 may also have another output for recovered exothermic heat released by the chemical reaction.

In accordance with an embodiment of the disclosure, a continuous feed of the aluminum slurry 202 into the hydrogen reactor 201 is regulated and controlled to a target flow rate during the chemical reaction, and meanwhile pressure and temperature within the hydrogen reactor 201 are controlled and regulated as well, such that a desired purity can be achieved for the hydrogen 206 and the alumina 208 being continuously produced by the chemical reaction with a relatively high degree of production efficiency. In particular implementations, the continuous feed of the aluminum slurry 202 into the hydrogen reactor 201 is regulated to an operable range between 1000 lbs/hr to 2500 lbs/hr, for example 2000 lbs/hr. Also, in particular implementations, the pressure is regulated to a target pressure in an operable range of between 1950 PSIG (Pounds per Square Inch Gauge) to 2050 PSIG, for example 2000 PSIG. Also, in particular implementations, the temperature is regulated to a target temperature in an operable range of between 450° C. to 540° C., for example 482° C. By controlling and regulating the pressure and the temperature within these ranges whilst the continuous feed of the aluminum slurry 202 is regulated and controlled as well, it is possible to achieve the desired purity for the hydrogen 206 and the alumina 208 being continuously produced by the chemical reaction with a relatively high degree of production efficiency.

Conventional approaches for producing hydrogen and alumina are typically limited to small batch type operations that are not continuous, and hence may not achieve the same production efficiency. Moreover, the conventional approaches may not allow the pressure and the temperature to be remain elevated in the same controlled and regulated way, and hence may not achieve the same purity. Those skilled in the art will appreciate that the target pressure and the target temperature are high but not so high so as to cause damage to the hydrogen reactor 201 or other components of the hydrogen reactor system. Meanwhile, the target pressure and the target temperature can enable high yield quality and high efficiency. Therefore, the regulating and the controlling of the pressure and the temperature within the hydrogen reactor 201 whilst the aluminum slurry 202 is continuously supplied can provide for substantial benefits over the conventional approaches.

In some implementations, the target flow rate of the aluminum slurry 202 into the hydrogen reactor 201 ensures that aluminum particles will always remain in suspension and also ensures a suitable ratio of aluminum to water for the chemical reaction. Note that the target flow rate may depend on a size of the hydrogen reactor 201. In some implementations, as described below, a back pressure control valve 238 is configured to regulate and control pressure of the aluminum slurry 202 being fed into the hydrogen reactor 201. Therefore, the aluminum slurry 202 is injected into the hydrogen reactor 201 through the slurry injection nozzle 203 at a controlled flow rate.

In some implementations, the slurry injection nozzle 203 is cooled using cooling water 204 that is directed to an inlet section of the hydrogen reactor 201 to prevent a premature chemical reaction in a front and slurry feed area. This can ensure that the chemical reaction occurs in a high temperature cooling section of the hydrogen reactor 201 where the exothermic heat can be recovered and used for other process purposes.

In some implementations, the aluminum slurry includes a catalyst in addition to the aluminum and the water.

There are many ways to regulate the pressure within the hydrogen reactor 201. In some implementations, an inert gas 210 is supplied to the hydrogen reactor 201 to initially bring pressure inside the hydrogen reactor 201 up to the target pressure. The inert gas 210 can for example be argon, nitrogen, or other suitable inert gas or mixture of inert gases. Then, during operation, the target pressure inside the hydrogen reactor 201 is maintained whilst the aluminum slurry 202 is added, and whilst the hydrogen 206 and the alumina 208 are extracted. In some implementations, the inert gas 210 is only supplied to the hydrogen reactor 201 during startup, or after operations are complete to purge any remaining hydrogen gas from the hydrogen reactor 201, but is not supplied to the hydrogen reactor 201 while the chemical reaction is occurring.

In accordance with an embodiment of the disclosure, the hydrogen reactor system has a back pressure control valve 212 configured to maintain the pressure in the hydrogen reactor 201 and release the hydrogen 206 at a flow rate that is variable such that the target pressure inside the hydrogen reactor 201 is maintained. In particular, the back pressure control valve 212 operates off a pressure sensor (not shown) at a discharge of the hydrogen reactor 201, and if measured pressure inside the hydrogen reactor 201 deviates above the target pressure, then the flow rate of the hydrogen 206 increases to reduce the pressure inside the hydrogen reactor 201. Conversely, if the measured pressure inside the hydrogen reactor 201 deviates below the target pressure, then the flow rate of the hydrogen 206 reduces to increase the pressure inside the hydrogen reactor 201. As a result, the back pressure control valve 212 regulates the pressure inside the hydrogen reactor 201 to substantially track the target pressure. By adjusting the pressure based on the measured pressure, the hydrogen reactor system implements feedback control to regulate and control the pressure. As a result, the pressure in the hydrogen reactor 201 can track the target pressure without much deviation.

It is noted that the back pressure control valve 212 releases the hydrogen 206 whilst the aluminum slurry 202 is being added and whilst the alumina 208 is being extracted. The aluminum slurry 202 is subjected to pressure that normally equals (or exceeds) the target pressure inside the hydrogen reactor 201, such that the aluminum slurry 202 may flow into the hydrogen reactor 201. For instance, as explained below, a slurry feed valve 214 can be used to feed the aluminum slurry 202 into the hydrogen reactor 201 under pressure. Also explained below, the alumina 208 can be extracted by a wet alumina discharge system and/or a screw conveyor system to a sealed collection vessel.

There are many ways to regulate the temperature within the hydrogen reactor 201. In some implementations, an ingress thermal fluid 218 is supplied to the hydrogen reactor 201, which bathes the hydrogen reactor 201 within a cooling jacket 222, and is expelled as egress thermal fluid 220. In some implementations, as described below, the egress thermal fluid 220 is recirculated back to become the ingress thermal fluid 218. In some implementations, the ingress thermal fluid 218 is heated (e.g. by an electric immersion heater 276) initially until the hydrogen reactor 201 reaches an ignition temperature at which point the chemical reaction begins. However, once the chemical reaction is underway, heating of the ingress thermal fluid 218 can be turned off, as the temperature of the hydrogen reactor 201 will naturally increase because the chemical reaction is exothermic. Once the temperature of the hydrogen reactor 201 rises up to the target temperature, the ingress thermal fluid 218 is cooled, such that the hydrogen reactor 201 is maintained at the target temperature. For instance, as explained below, when the egress thermal fluid 220 is recirculated back to become the ingress thermal fluid 218, it is first cooled via a heat exchanger (e.g. an air cooled heat exchanger 277).

Although not shown, the hydrogen reactor 201 comprises one or more temperature sensors to enable monitoring of the temperature in the hydrogen reactor 201. In the case of multiple temperature sensors, they can be distributed throughout the hydrogen reactor 201 to monitor temperature in different regions of the hydrogen reactor 201. A weighted average of the multiple temperature sensors can be performed to gauge the temperature in the hydrogen reactor 201. Alternatively, another mathematical function, such as median function for example, can be employed to determine the temperature of the hydrogen reactor 201 and whether more or less cooling is to be performed to regulate and control the temperature to track the target temperature. By adjusting the cooling based on measured temperature, the hydrogen reactor system implements feedback control to regulate and control the temperature. As a result, the temperature in the hydrogen reactor 201 can track the target temperature without much deviation.

In some implementations, the thermal fluid 218 and 220 is demineralized water and remains as a liquid even at the target temperatures in the hydrogen reactor 201, because the thermal fluid 218 and 220 is under substantial pressure inside the hydrogen reactor 201 to ensure that it remains in liquid form. In other implementations, another fluid is utilized for the thermal fluid 218 and 220.

In some implementations, the hydrogen reactor system also has components that may be used when initializing and/or shutting down the hydrogen reactor 201. For instance, the hydrogen reactor system may have a gas depressurization valve 213 configured to bypass the back pressure control valve 212 and safety valve to purge the system with the inert gas 210 prior to and after operation. Also, in some implementations the the hydrogen reactor system 200 may have a maintenance drain 205.

For generating the aluminum slurry 202, the hydrogen reactor system 200 comprises a slurry mixing tank 224 which receives granulated aluminum 226 and demineralized water 228, and mixes the granulated aluminum 226 and the demineralized water 228 to produce the aluminum slurry 202. The aluminum slurry 202 coming out of the slurry mixing tank 224 is fed through a positive displacement slurry pump 234, which is configured to increase pressure of the aluminum slurry 202 to be equal to (or greater than) the target pressure in the hydrogen reactor 201 so that it may be pumped into the hydrogen reactor 201 through the slurry feed valve 214. The slurry flow is operated at a set speed to maintain the slurry flow at a constant flow rate to ensure that the aluminum remains in suspension at all times and is supplied to the hydrogen reactor 201 at a suitable ratio of water to aluminum. The aluminum slurry 202 is supplied to the hydrogen reactor 201 via the slurry feed valve 214. The slurry feed valve 214 is controlled based on signals from a flow control measurement element 236 in the feed line to the feed valve 214 and the recirculation line back to the slurry mixing tank 224. A controller of the hydrogen reaction system 200 monitors a differential between the slurry feed line and the slurry recirculation line and uses this signal to set point for slurry feed valve 214 to the slurry flow into the hydrogen reactor 201.

In accordance with an embodiment of the disclosure, the hydrogen reactor system has a back pressure control valve 238 configured to regulate and control pressure of the aluminum slurry 202 being fed into the hydrogen reactor 201. In particular, if the pressure of the aluminum slurry 202 deviates above the target pressure, then a flow rate of the aluminum slurry 202 going back to the aluminum and slurry tank and mixer 224 increases to reduce the pressure of the aluminum slurry 202 going to the hydrogen reactor 201. Conversely, if the pressure of the aluminum slurry 202 deviates below the target pressure, then the flow rate of the aluminum slurry 202 going back to the slurry mixing tank 224 reduces to increase the pressure of the aluminum slurry 202 going to the hydrogen reactor 201. As a result, the back pressure control valve 238 regulates the pressure inside of the aluminum slurry 202 going to the hydrogen reactor 201 based on the target pressure.

In some implementations, the slurry mixing tank 224 has an exhaust fan 230 to atmosphere and a vent 232 to maintain the slurry mixing tank 224 at atmospheric conditions. Given that some of the aluminum slurry 202 is fed back into the slurry mixing tank 224 via the back pressure control valve 238, there is a slight potential that small amounts of hydrogen could be produced in the slurry mixing tank 224. The exhaust fan 230 to atmosphere and the vent 232 ensure that gasses in the slurry mixing tank 224 are evacuated outdoors to a safe location.

As noted above, the back pressure control valve 212 allows the hydrogen 206 to be extracted from the hydrogen reactor 201 whilst regulating and controlling the pressure inside the hydrogen reactor 201 to substantially track the target pressure. In some implementations, the hydrogen 206 is cooled by a hydrogen gas cooler 239, and then pressure is decreased by a hydrogen pressure regulator 240. Note that the hydrogen 206 may have some water vapor when extracted from the hydrogen reactor 201, and hence some water condensation may occur after cooling and pressure reduction. Thus, in some implementations, a water separator 242 separates any water from the hydrogen 206, and any collected water goes to a drain 244. In some implementations, there is provided a desiccant filter 246 and/or a particulate filter 248 to remove any particles/impurities from the hydrogen 206 prior to being stored in a hydrogen storage tank 250. In some implementations, the hydrogen storage tank 250 may also have a connection to a hydrogen distribution system.

In some implementations, the hydrogen reactor system 200 has a first vent to atmosphere 252 and/or a second vent to atmosphere 254 in the hydrogen collection circuit, which are configured to release the hydrogen 206 to the atmosphere for safety purposes in an event of pressure being too high. Additional or alternative components may be provided for safety purposes.

For extracting and collecting the alumina 208, a spray/make-up water valve 216 provides water to the alumina/hydrogen separator 207 which pre-emptively cools the alumina 208 and makes a slurry out of the alumina 208 prior to leaving the hydrogen reactor 201. The alumina 208 in slurry form is passed through a blowdown valve 255 which is configured to reduce pressure of the slurry prior to entering a blowdown collection tank 256. In some implementations, the blowdown collection tank 256 further reduces pressure of the slurry. An alumina/water centrifuge/separator 257 is configured to separate the slurry into alumina for alumina collection 258 and water which can be recirculated to the spray/make-up water valve 216. In some implementations, in order to recirculate the water to the spray/wake-up water valve 216, the hydrogen reactor system 200 has a circulating water pump 259 configured to pump the water from the alumina/water centrifuge/separator 257 through a recirculation water cooler 260 and into a circulating water tank 261, and a cooling water spray booster pump 262 configured to pump water to the spray/wake-up water valve 216. In some implementations, the circulating water tank 261 is connected to a domestic water supply 263 via a make-up water vale 262. The domestic water can be initially supplied until there is enough water in the circulating water tank 261. When there is sufficient water which is being recirculated, the supply of the domestic water can be turned off.

In some implementations, the blowdown collection tank 256 has a vent to atmosphere 265, which is configured to release pressure of the system to atmospheric of slightly above atmospheric conditions for further processing of the alumina/water slurry mixture. Additional or alternative components may be provided to reduce the process pressure and for safety purposes.

As noted above, the ingress thermal fluid 218 enters the hydrogen reactor 201, bathes the hydrogen reactor 201 within the cooling jacket 222, and leaves as the egress thermal fluid 220. In some implementations, the egress thermal fluid 220 is recirculated. Additionally, or alternatively, a demineralized water supply 270 may be used to provide the ingress thermal fluid 218. In the case of the egress thermal fluid 220 being recirculated as shown, the demineralized water supply 270 can be initially opened up until there is enough of the thermal fluid 218 and 220 in the hydrogen reactor system 200 at which point the of the demineralized water supply 270 can be turned off because the demineralized water circulates in a closed loop system.

The demineralized water from the demineralized water supply 270 and/or the egress thermal fluid 220 is passed through an air separator 271, which is configured to remove any air from the demineralized water and expel that air via an automatic air vent 272. In some implementations, a thermal fluid circulating pump 273 pumps the demineralized water through a thermal fluid control valve 274, a thermal fluid flow element 275 and an electric emersion heater 276 prior to arriving at the hydrogen reactor 201 as the ingress thermal fluid 218. The thermal fluid control valve 274 can be controlled by an FIC (Flow Indicator Controller) based on flow measured by the thermal fluid flow element 275. The electric emersion heater 276 is configured to initially heat the ingress thermal fluid 218 during start-up until the temperature of the hydrogen reactor 201 reaches a point at which the chemical reaction begins, as described above. After the chemical reaction begins, the electric emersion heater 276 can stop heating the ingress thermal fluid 218, as described above.

In some implementations, the egress thermal fluid 220 coming out of the hydrogen reactor 201 is cooled by an air cooled heat exchanger 277. In some implementations, an amount of cooling is adjustable via a temperature control valve 278, which is configured to adjust how much of the egress thermal fluid 220 passes through the air cooled heat exchanger 277 instead of bypassing the air cooled heat exchanger 277. Increasing how much of the egress thermal fluid 220 passes through the air cooled heat exchanger 277 increases the cooling. Conversely, decreasing how much of the egress thermal fluid 220 passes through the air cooled heat exchanger 277 decreases the cooling. In other implementations, the egress thermal fluid 220 is cooled by other means capable of extracting energy from the egress thermal fluid 220 and converting the same into electricity, process heating and cooling, etc. which can be used for some other purpose.

In some implementations, some of the egress thermal fluid 220 coming out of the hydrogen reactor 201 is also supplied to a pressurizer vessel 280, which is configured to maintain the pressure in the thermal fluid circuit and ensure that the thermal fluid remains in a liquid state. The pressurizer vessel 280 is filled with a pressurized gas 281, which passes through a supply control valve 282 and a back pressure control valve 283, which control an amount of pressure for the pressurized gas 281. A level control valve 284 is configured to limit how much of the egress thermal fluid 220 is allowed to fill inside the pressurizer vessel 280. An excess amount of the egress thermal fluid 220 can be expelled blowdown/collection tank 256. Also, a discharge control valve 285 and a flow restriction orifice 286 are coupled to a vent to atmosphere 287 to limit a pressure inside the pressurizer vessel 298.

The pressurized gas 299 can be used to provide the purging gas 210 to the hydrogen reactor 201 via a pressure control valve 308. In some implementations, the pressurized gas 299 is an inert gas from an inert gas supply 310. In the illustrated example, a process for pressurizing the purging gas 210 is dependant upon a process for circulating and cooling the thermal fluid 218 and 220. However, other implementations are possible in which the process for pressurizing the purging gas 210 is independent of the process for circulating and cooling the thermal fluid 218 and 220.

In some implementations, the pressurizer vessel 280 also has a vent to atmosphere 288, which is configured to release pressure for safety purposes in an event of pressure being too high. Additional or alternative components may be provided for safety purposes.

In some implementations, the demineralized water supply 270 for the thermal fluid circuit stems from a demineralized water tank 266. The demineralized water tank 266 has a fill connection 267 to an external demineralized water supply 268, a drain connection to drain 269, and supply connection to the thermal circuit provide the demineralized water supply 270. In some implementations, the demineralized water tank 266 has a capacity that ensures there is enough of the demineralized water to be utilized by the hydrogen reactor system 200 for at least a predetermined time period without relying on the external demineralized water supply 268.

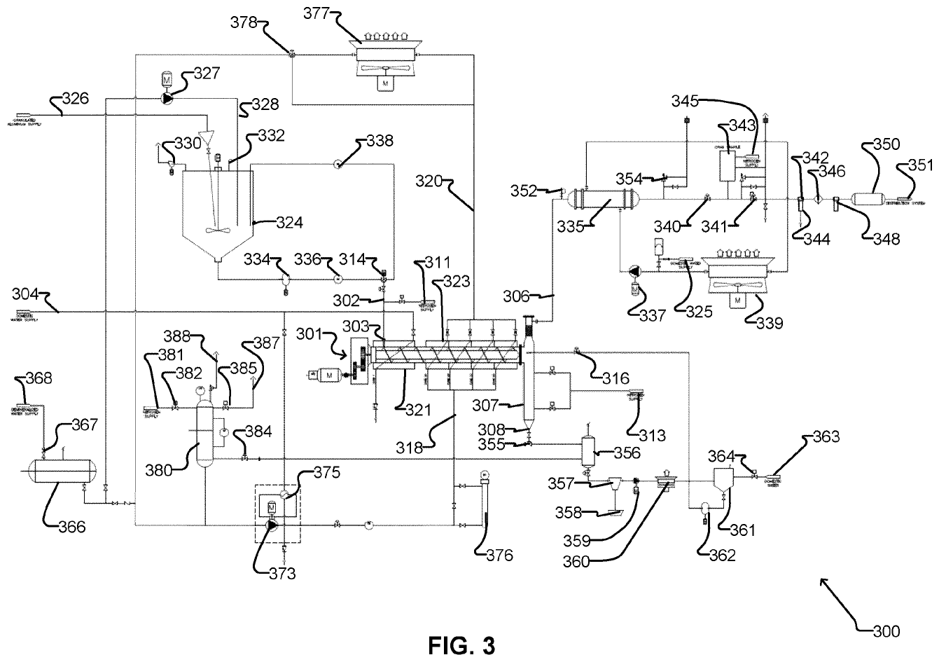

FIG. 3 shows a schematic of another example hydrogen reactor system 300 in accordance with another embodiment of the disclosure. It is to be understood that the hydrogen reactor system 300 is very specific and is provided merely for exemplary purposes. The hydrogen reactor system 300 of FIG. 3 is different from the hydrogen reactor system 200 of FIG. 2, however basic operation and underlying principles of systems 200 and 300 are similar and hence not all of the components of system 300 are described in detail.

As with the FIG. 2 example, the hydrogen reactor system 300 comprises a hydrogen reactor 301 which receives aluminum slurry 302 under pressure from a slurry mixing tank 324. The slurry mixing tank 324 receives granulated aluminum 328 and demineralized water, which are mixed to produce the slurry 302, and may comprise an exhaust fan 330 and vent 332. The demineralized water 328 may, for example be provided through a pump 327 connected to a demineralized water tank 366, having a connection 367 to an external demineralized water supply 368. The pressure of the slurry 302 is controlled by a positive displacement slurry pump 334, flow control measurement element 336, slurry feed valve 314, and back pressure control valve 338.

However, unlike the FIG. 2 example, instead of a water cooled slurry injection nozzle connected to receive colling water as in the FIG. 2 example, in system 300 of FIG. 3 the injection nozzle 303 only receives the aluminum slurry 302, and cooling water from a domestic water supply 304 is separately delivered to a first stage cooling jacket 321 near an input end of the hydrogen reactor 301. The injection nozzle 303 may also be selectively connected to an inert gas supply 311 for purging the hydrogen reactor 301, and/or for pressurizing the hydrogen reactor 301 during startup. Another inert gas supply 313 may be selectively connected to the alumina/hydrogen separator 307 at the discharge end of the hydrogen reactor 301.

Ingress thermal fluid 318 (which may be demineralized water provided from tank 366, or another type of thermal fluid) is provided to a second stage cooling jacket 323 near the discharge end of the hydrogen reactor 301. In some implementations the ingress thermal fluid 318 is provided to a plurality of zones defined within the second stage cooling jacket 323. The ingress thermal fluid 318 may be selectively passed through an electric immersion heater 376 during startup until the hydrogen reactor 301 reaches the ignition temperature to start the chemical reaction. The egress thermal fluid 320 exiting the second stage cooling jacket 323 is selectively provided to an air cooled heat exchanger 377 under control of a temperature control valve 378, and is recirculated through a thermal fluid circulating pump 373 back to become the ingress thermal fluid 318. The thermal fluid may also be cooled at the thermal fluid circulating pump 373 by a heat exchanger 375 selectively connected to the domestic water supply 304.

The thermal fluid circuit may also be connected to a pressurizer vessel 380, which receives inert gas from an inert gas supply 381 through a back pressure control valve 382. The amount of thermal fluid in the pressurizer vessel 380 may be controlled by a level control valve 384, and excess thermal fluid may be provided to the blowdown collection tank 356. The pressurizer vessel 380 may also have a discharge control valve 385 connected to a vent to atmosphere 287 to limit the pressure inside the pressurizer vessel 280, as well as a safety vent 388.

As with the FIG. 2 example, alumina 308 exits the alumina/hydrogen separator 307 and passes through a blowdown valve 355 to a blowdown collection tank 357, then to an alumina/water centrifuge/separator 357 an finally to alumina collection 358. Water removed from the alumina by the centrifuge/separator 357 is provided to a pump 359, through a cooer 360 and to a circulating water tank 361, then through another pump 362 and make-up water valve 316 to be sprayed into the alumina/hydrogen separator 307. The circulating water tank 361 may be connected to a domestic water supply 363 through a make-up water valve 364, and water may be added to the system as needed.

Unlike the FIG. 2 example, hydrogen 306 exiting the alumina/hydrogen separator 307 of system 300 is provided to a tubular heat exchanger 335, where it is cooled by domestic water provided through a pump 337 from a domestic water supply 325. The domestic water exiting the tubular heat exchanger is recirculated back to the pump 337 through an air cooled heat exchanger 339. The hydrogen collection portion of system 300 also differs from the FIG. 2 example in that a sampling port 343 is provided downstream of the tubular heat exchanger 335. In the illustrated example, the sampling port 343 is located between a back pressure control valve 340 and a hydrogen pressure regulator 341. An operator may use the sampling port 343 to obtain a sample of hydrogen gas during operation for testing and quality control. The sampling port 343 may also have a connection to an inert gas supply for purging hydrogen gas. Similar to the FIG. 2 example, hydrogen produced by the hydrogen reactor system 300 of FIG. 3 passes through a water separator 342 having a drain 344, a desiccant filter 346 and a particulate filter 348 en route to a hydrogen collection tank 350. The hydrogen collection tank 350 has an output to a hydrogen distribution system connection 351.

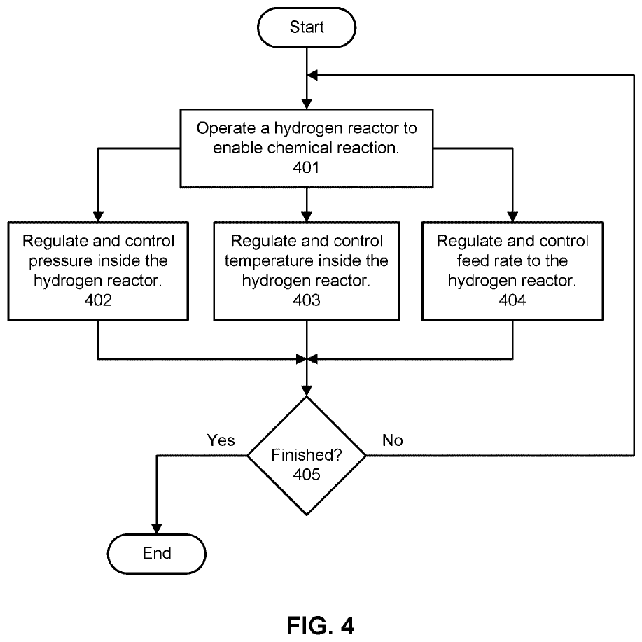

Referring now to FIG. 4, shown is a flowchart of a method of continuously producing hydrogen and alumina with pressure and temperature regulation and control. This method may be implemented in conjunction with a hydrogen reactor system, for example any of the hydrogen reactor systems 100, 200, and 300 of FIGS. 1 to 3. More generally, this method may be implemented in conjunction with any appropriately configured hydrogen reactor system.

At step 401, a hydrogen reactor is operated to enable a chemical reaction involving aluminum and water to produce hydrogen and alumina. At step 402, pressure inside the hydrogen reactor is regulated and controlled to a target pressure during the chemical reaction. At the same time, at step 403, temperature inside the hydrogen reactor is regulated and controlled to a target temperature during the chemical reaction. At step 404, a feed rate of aluminum slurry into the hydrogen reactor is regulated and controlled to a target flow rate. This can occur concurrently with steps 402 and 403 once the pressure and the temperature targets have been achieved.

Because the pressure and the temperature within the hydrogen reactor are controlled and regulated, the pressure and the temperature can be purposely operated in an elevated manner, which can increase purity of the hydrogen and the alumina being continuously produced by the chemical reaction with a relatively high degree of production efficiency. Example details of how the pressure and the temperature within the hydrogen reactor can be regulated and controlled along with the feed rate of the aluminum slurry have been provided above and thus are not repeated here.

If at step 405 the chemical reaction is not finished, then the method repeats through steps 401 to 404. Note that more and more aluminum and water can be added to the hydrogen reactor on an ongoing basis to keep the chemical reaction going continuously for as long as desired. However, if at step 405 the chemical reaction is finished, then the method ends.

Numerous modifications and variations of the present disclosure are possible in light of the above teachings. It is therefore to be understood that within the scope of the appended claims, the disclosure may be practised otherwise than as specifically described herein.

1. A hydrogen reactor system, comprising:
a hydrogen reactor configured to enable a chemical reaction involving aluminum and water to produce hydrogen and alumina;
a pressure regulator configured to regulate and control pressure inside the hydrogen reactor to a target pressure during the chemical reaction;
a temperature regulator configured to regulate and control temperature inside the hydrogen reactor to a target temperature during the chemical reaction; and
an aluminum slurry feed regulator configured to regulate and control a continuous feed of the aluminum and the water as an aluminum slurry to a target flow rate into the hydrogen reactor during the chemical reaction, thereby enabling the hydrogen and the alumina to be continuously produced at a controlled rate.

2. The hydrogen reactor system of claim 1, wherein the hydrogen reactor system comprises a pressure sensor and the pressure regulator implements feedback control based on measurements from the pressure sensor to regulate and control pressure inside the hydrogen reactor to the target pressure.

3. The hydrogen reactor system of claim 1, wherein the pressure regulator comprises a back-pressure control valve configured to release the hydrogen from the hydrogen reactor at a flow rate that is variable such that the target pressure inside the hydrogen reactor is maintained.

4. The hydrogen reactor system of claim 1, wherein the target pressure inside the hydrogen reactor is within an operating range between 1950 PSIG (Pounds per Square Inch Gauge) to 2050 PSIG.

5. The hydrogen reactor system of claim 1, further comprising a supply of inert gas configured to initially raise the pressure inside the hydrogen reactor to the target pressure prior to the chemical reaction.

6. The hydrogen reactor system of claim 1, wherein the hydrogen reactor system comprises a temperature sensor and the temperature regulator implements feedback control based on measurements from the temperature sensor to regulate and control temperature inside the hydrogen reactor to the target temperature.

7. The hydrogen reactor system of claim 1, wherein the hydrogen reactor is cooled using thermal fluid, and the temperature regulator comprises a temperature control valve configured to adjust how much of the thermal fluid passes through a heat exchanger to cool the thermal fluid.

8. The hydrogen reactor system of claim 1, wherein the target temperature of the hydrogen reactor is within an operating range between 450° C. to 540° C.

9. The hydrogen reactor system of claim 1, further comprising a heater configured to initially heat the hydrogen reactor until the chemical reaction begins.

10. The hydrogen reactor system of claim 1, wherein the hydrogen reactor system comprises a feed control flow sensor and the aluminum slurry feed regulator implements feedback control based on measurements from the feed control flow sensor to regulate and control the continuous feed of the aluminum slurry into the hydrogen reactor to the target flow rate.

11. The hydrogen reactor system of claim 1, wherein the target flow rate of the aluminum slurry into the hydrogen reactor is within an operating range between 1000 lbs/hr to 2500 lbs/hr.

12. The hydrogen reactor system of claim 1, wherein the aluminum slurry comprises a catalyst in addition to the aluminum and the water

13. A method for continuously producing hydrogen and alumina with pressure and temperature regulation and control, comprising:
operating a hydrogen reactor to enable a chemical reaction involving aluminum and water to produce hydrogen and alumina;
regulating and controlling pressure inside the hydrogen reactor to a target pressure during the chemical reaction;
regulating and controlling temperature inside the hydrogen reactor to a target temperature during the chemical reaction; and
regulating and controlling a continuous feed of the aluminum and the water as an aluminum slurry into the hydrogen reactor to a target flow rate during the chemical reaction, thereby enabling the hydrogen and the alumina to be continuously produced at a controlled rate.

14. The method of claim 13, wherein regulating and controlling pressure inside the hydrogen reactor comprises measuring pressure and implementing feedback control based on the measured pressure to regulate and control pressure inside the hydrogen reactor to the target pressure.

15. The method of claim 13, wherein the target pressure inside the hydrogen reactor is within an operating range between 1950 PSIG (Pounds per Square Inch Gauge) to 2050 PSIG.

16. The method of claim 13, wherein regulating and controlling temperature inside the hydrogen reactor comprises measuring temperature and implementing feedback control based on the measured temperature to regulate and control temperature inside the hydrogen reactor to the target temperature.

17. The method of claim 13, wherein the target temperature of the hydrogen reactor is within an operating range between 450° C. to 540° C.

18. The method of claim 13, wherein the aluminum slurry comprises a catalyst in addition to the aluminum and the water.

19. A hydrogen reactor system, comprising:
a hydrogen reactor configured to enable a chemical reaction involving aluminum and water to produce hydrogen and alumina; and
an aluminum slurry feed regulator configured to regulate and control a continuous feed of the aluminum and the water as an aluminum slurry to a target flow rate into the hydrogen reactor during the chemical reaction, thereby enabling the hydrogen and the alumina to be continuously produced at a controlled rate.

20. (canceled)
